(19) United States
(12) Patent Application Publication
(10) Pub. No.: US 2026/0109237 A1
(43) Pub. Date: Apr. 23, 2026

(54) Method and Device for Calculating Target Battery State of Charge (SOC) for Front Segments Based on Forward Driving Information of a Fuel Cell Vehicle

(71) Applicants: Hyundai Motor Company, Seoul (KR); Kia Corporation, Seoul (KR)

(72) Inventor: Sang Pil Jang, Hwaseong-Si (KR)

(21) Appl. No.: 19/226,774

(22) Filed: Jun. 3, 2025

(30) Foreign Application Priority Data
Oct. 23, 2024 (KR) 10-2024-0145515

(51) Int. Cl. B60L 15/20; B60L 50/75

(52) U.S. Cl. CPC B60L 15/2045; B60L 50/75; B60L 2240/54; B60L 2240/642; B60L 2240/80

(57) ABSTRACT

A method for determining a target battery SOC of a vehicle, the method comprising: obtaining upcoming segment information for each of at least two upcoming segments of an upcoming segment of a road; determining and/or calculating an expected battery SOC demand value of each segment based on the obtained upcoming segment information; determining and/or calculating a target battery SOC demand value in a current driving segment according to whether the at least two upcoming segments shift gradients.

### CROSS REFERENCE TO RELATED APPLICATION

The present application claims priority to a Korean application 10-2024-0145515, filed on Oct. 23, 2024, the entire contents of which are incorporated herein for all purposes by this reference.

### TECHNICAL FIELD

The present disclosure relates to a method and device for determining a battery state of charge (SOC) of a fuel cell vehicle by using upcoming segment information of the vehicle, and more particularly, to a method and device for determining a target battery SOC by considering information obtained from a peripheral device according to each segment in front of a vehicle.

### BACKGROUND

Generally, a vehicle (alternatively referred to herein as a ‘moving object’) may be controlled depending on a current state of the vehicle and/or a current driver's input. In a conventional fuel cell power generation control method for a fuel cell electric vehicle (FCEV), a fuel cell (FC) power map according to a state of charge (SOC) of a high-voltage battery may be determined based on (e.g., by calculating) a vehicle output power demand. The vehicle output power demand may be determined based on a driver's acceleration pedal engagement amount and a service output power of vehicle accessories.

Specifically, a conventional FCEV controls fuel cell power generation based on a FC power map that reflects an SOC of a battery of the FCEV (e.g., a high-voltage battery). The FC power map may be determined based on (e.g., by calculating) the vehicle output power demand based on a driver's acceleration pedal engagement amount and a service output power of vehicle accessories. In this case, even when a an upcoming segment of a road to be driven on (e.g., in future based on a current location/trajectory) is an uphill segment (e.g., ascending road of at least a threshold length and/or slope) or a downhill segment (e.g., descending road of at least a threshold length and/or slope), power is generated merely according to the FC power map in a current driving segment, there is a problem in that a battery SOC necessary for the future driving segment is not sufficiently/accurately predicted/determined and thereby secured.

Existing technologies may predict a battery SOC demand value of an upcoming segment without considering the slope/gradient/conditions of the upcoming segment or changes/shifts in the slope/gradient/conditions (e.g., if the upcoming segment includes subsegments having different slopes/gradients/conditions). Existing technologies may predict a battery SOC demand value of an upcoming segment without considering an uphill/downhill change of the upcoming segment, and thus an error occurs that an accurate battery SOC value is not calculated. That is, an existing FCEV does not consider whether one or more (e.g., two or more distinct) upcoming segments have continuous gradients or a shift of gradients and fails to predict an accurate battery SOC value in a current driving segment. Consequently, when the vehicle moves from a current driving segment to the upcoming segment, a required battery SOC value may not be satisfied.

Thus, it is necessary to more accurately determine/calculate a target battery SOC value according to various situations.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for determining a battery state of charge for controlling fuel cell power generation. A method, performed by a device of a vehicle and for controlling power generation based on a target battery state of charge (SOC) of a battery of the vehicle, may comprise: obtaining upcoming segment information for each of at least two upcoming segments of a road, wherein the at least two upcoming segments of the road are segments of the road to be driven on following a current segment of the road; determining, based on the obtained upcoming segment information, expected battery SOC demand values for the at least two upcoming segments; based on whether there is a change in direction of gradients of the at least two upcoming segments and based on the expected battery SOC demand values, determining a target battery SOC value for a current driving segment; and controlling, based on the target battery SOC demand value, power generation by a fuel cell of the vehicle.

A device may allow for determining a target battery state of charge (SOC) for fuel cell power generation control of a fuel cell of a vehicle. The device may comprise: a peripheral device configured to obtain upcoming segment information about at least two upcoming segments of a road comprising a current segment on which the vehicle is driving, wherein the upcoming segment information indicates gradients of the at least two upcoming segments and comprises at least one of: a driving distance of each of the at least two upcoming segments, or a speed limit of each of the at least two upcoming segments. The device may further comprise a memory storing at least one instruction: and a processor configured to execute the at least one instruction stored in the memory, wherein the at least one instruction, when executed by the processor, configures the processor to: determine, based on the upcoming segment information from the peripheral device, expected battery SOC demand values for the at least two upcoming segments, based on whether there is a change in direction of gradients of the at least two upcoming segments and based on the expected battery SOC demand values, a target battery SOC value for a current driving segment; and control, based on the target battery SOC demand value, power generation by the fuel cell of the vehicle.

A fuel cell vehicle may comprise one or more sensors configured to obtain gradient information about at least two upcoming segments of a road comprising a current segment on which the fuel cell vehicle is driving; and a computing device comprising: a processor; and memory storing instructions that, when executed by the processor, configure the computing device to: determine, based the gradient information indicating a change in direction of gradients of the at least two upcoming segments, one of a plurality of algorithms for determining a target battery SOC demand value for a current driving segment, wherein each of the plurality of algorithms is different from a first algorithm that uses a sum of expected battery SOC demand values for the at least two upcoming segments, and wherein the first algorithm is configured to be used when there is no change in direction of gradients of the at least two upcoming segments; and control, based on the target battery SOC demand value, power generation by a fuel cell of the fuel cell vehicle.

These and other features and advantages are described in greater detail below.

### BRIEF DESCRIPTION OF THE DRAWINGS

FIG. 1 is a block diagram illustrating constituent modules of a vehicle equipped with a device for determining a target battery SOC according to an example of the present disclosure.

FIG. 2A and FIG. 2B are flowcharts of a method for determining a target battery SOC value of a vehicle according to another example of the present disclosure.

FIG. 3A and FIG. 3B are graphs showing estimation results of changes in a target battery SOC value for each upcoming segment of a road according to a continuous front gradient, given results obtained from a device for determining a target battery SOC value in a vehicle according to another example of the present disclosure.

FIGS. 4A, 4B, 4C and 4D are graphs showing estimation results of changes in a target battery SOC value for each upcoming segment of a road according to a shift of front gradient, given the results obtained from a device for determining a target battery SOC value in a vehicle.

FIG. 5 is a view exemplifying a flowchart of an operating mechanism of a device for determining a target battery SOC value according to another example of the present disclosure.

FIGS. 6A, 6B and 6C are views showing internal circuit structures of a process of implementing an operating mechanism for a device for determining a target battery SOC value according to another example of the present disclosure.

### DETAILED DESCRIPTION

Hereinafter, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, an element being “connected to”, “coupled to” or “linked to” another element may mean the element is “directly connected to”, “directly coupled to”, or “directly linked to” the other element or this may mean that an element is connected to, coupled to, or linked to the other element with still another element intervening therebetween. In addition, if an element “includes” or “has” another element, this means that one element may further include another element without excluding another component unless specifically stated otherwise.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. This definition also applies to “at least X of . . . ” where X is any integer.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

Here, electrical devices refer to those related to battery charging and discharging in the vehicle, including a drive motor and a starter generator (HSG) that can charge the battery by converting the braking and inertial energy of the vehicle into electrical energy during regenerative braking or other driving conditions.

Here, a method is provided to reduce/minimize driving issues caused by smart power control. The method may perform limiting the target battery's SOC (State of Charge) change or adjusting the charging/discharging rate weight based on the reliability of the vehicle's driving path. The “reliability” of the driving path refers to the trustworthiness of the gradient information of the current driving path received by the smart power control logic. Even if the driving path changes, the reliability is considered high if the gradient information remains similar. For example, if transitioning from one uphill to another uphill path, the reliability is judged to be high. However, if the gradient information is likely to reverse due to a path change, such as transitioning from uphill to downhill, the reliability is considered low.

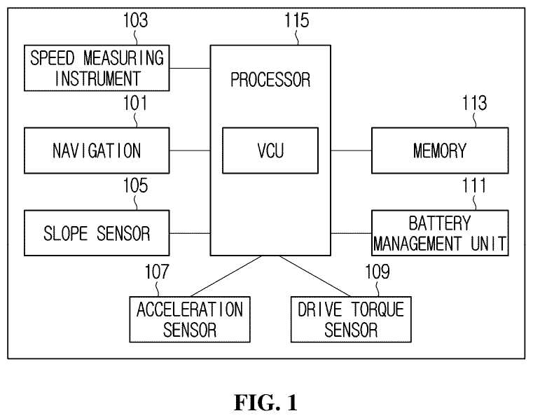

Hereinafter, referring to FIG. 1, a fuel cell power generation control device of a vehicle capable of determining a target battery SOC value based on upcoming segment information will be described according to an example of the present disclosure.

FIG. 1 is a block diagram illustrating constituent modules of a vehicle equipped with a device for determining a target battery SOC value according to an example of the present disclosure.

The device for determining a target battery SOC value may be mounted in a commercial hydrogen electric vehicle such as a large hydrogen electric truck. The device for determining a target battery SOC value may receive road gradient information of a front point a predetermined distance or more away from a vehicle, divide an upcoming segment of a road into two or more segments, calculate an expected battery SOC value for each segment of the upcoming segment of a road, and perform power control of the vehicle and determine a target battery SOC value. Herein, the target battery SOC value may be a value obtained by adding a battery SOC value required for driving on a current driving segment and an expected battery SOC value predicted according to a first upcoming segment and a second upcoming segment.

The device for determining a target battery SOC value may include a peripheral device, which may include a navigation unit 101, a speed measuring instrument 103, a slope sensor 105, an acceleration sensor 107 and/or a drive torque sensor 109, a battery management unit 111, and a memory 113. The peripheral device may be a device for acquiring upcoming segment information of the vehicle and may further include various devices other than the constituent elements illustrated in FIG. 1. In this regard, for example, the peripheral device may comprise and/or be part of integrated in a connected car Navigation Cockpit (ccNc) provided in the vehicle. The ccNC may perform a function of acquiring the upcoming segment information. Accordingly, the upcoming segment information according to the present disclosure may be obtained via the ccNc.

The navigation unit 101 may send out road information and/or repeated driving route information. Road information may include a vehicle speed limit of an upcoming segment of a road on which a vehicle is running. Repeated driving route information may be a route registered by a user or an automatically registered route based on driving repeated a predetermined number of times. The navigation unit may comprise a global positioning system (GPS) device configured to access GPS data or another computing device configured to receive map information and/or location information.

Apart from the navigation unit, the device for determining a target battery SOC value of the vehicle may include, as a peripheral device, the speed measuring instrument 103, the slope sensor 105, the acceleration sensor 107, and the drive torque sensor 109. The speed measuring instrument 103 may measure a driving speed of the vehicle, and the acceleration sensor 107 may measure not only a driving direction of the vehicle but also an acceleration in a different direction from the driving direction. In addition, a weight of the vehicle may be calculated through the acceleration sensor 107 and the drive torque sensor 109.

The battery management unit 111 may play a role to enhance energy efficiency by managing a state of charge (SOC) of a vehicle battery (e.g., optimally managing the SOC). Such a battery management unit may be implemented as a battery management system (BMS). The battery management unit may monitor the voltage, current and/or temperature of a vehicle battery in real time by using sensors. The battery management unit may prevent overcharge and/or overdischarge of a vehicle battery based on the monitoring. In addition, the battery management unit may calculate a SOC of a vehicle battery (battery SOC) by current and/or voltage measured by sensors. A vehicle battery may supply a power source to an electrical device mounted in a vehicle such as an electronic control unit (ECU) and/or a drive motor.

The memory 113 may store an application and/or various types of data for controlling a vehicle and at a request of a processor, load the application or read and record data. The memory may include a non-volatile memory and/or a volatile memory.

The processor 115 may perform overall control of the vehicle. The processor 115 may have at least one processing module, and each control-related function may be implemented in a single processing module or be implemented in a corresponding processing module among a plurality of modules. In relation to the present disclosure, the processor 115 may control the moving object to correct a battery SOC by using an application, an instruction and data stored in the memory.

Specifically, the processor 115 may obtain at least one of a driving distance of each segment of an upcoming segment of a road, a speed limit, and whether there is a gradient as upcoming segment information during driving of the vehicle and then calculate an expected battery SOC demand value based on the obtained upcoming segment information. In addition, in order to calculate and determine a target battery SOC value in a current driving segment based on an expected battery SOC demand value, the processor may calculate a battery charge/discharge SOC demand value according to whether at least two or more upcoming segments have a shift of gradient.

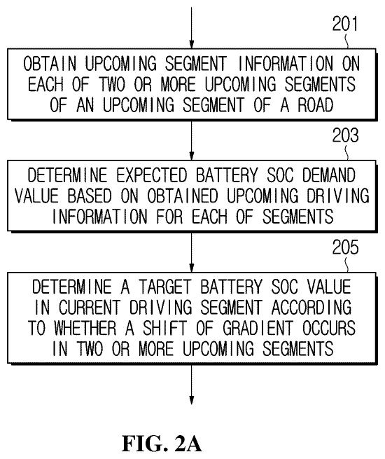

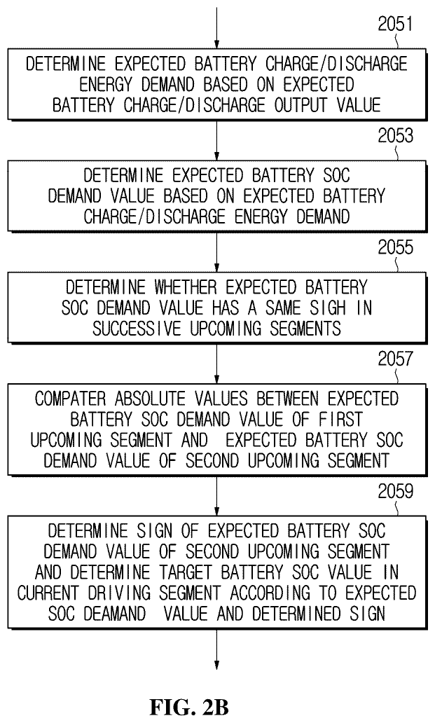

The device for determining a target battery SOC value of the vehicle according to the present disclosure may be a device configured to implement processing of correction of a battery SOC demand value through a processor by including at least the speed measuring instrument 103, the navigation unit 101, the slope sensor 105, the acceleration sensor 107, the drive torque 109, the memory 113, the battery management unit 111 and the processor 115. The processing may be implemented by at least a portion of the processor such as at least one processing module, and the memory may function as a vehicle control unit (VCU). The above-described processing of the processor will be described in detail through FIG. 2.

FIG. 2A and FIG. 2B are flowcharts of a method for determining a target battery SOC value of a vehicle according to another example of the present disclosure.

For convenience, FIGS. 2A and 2B are described by way of an example in which the steps are performed by a processor circuit. One, some, or all steps of the example methods of FIGS. 2A and 2B, or portions thereof, may be performed by one or more other circuits. One or some, steps of the example methods of FIGS. 2A and 2B may be omitted, performed in other orders, and/or otherwise modified, and/or one or more additional steps may be added.

Referring to FIG. 2A, a method for determining a target battery SOC value of a vehicle according to the present disclosure may include obtaining upcoming segment information on each of two or more upcoming segments of an upcoming segment of a road (201), determining an expected battery SOC demand value based on the obtained upcoming driving information for each of the upcoming segments (203), and/or determining a target battery SOC value in a current driving segment according to whether a shift of gradient occurs in the two or more upcoming segments (205).

First, in 201, the acquiring of the upcoming segment information on each of the two or more upcoming segments of the upcoming segment of a road may be performed by peripheral devices of the vehicle.

For example, the navigation unit 101 may provide information on a vehicle speed limit according to each segment of an upcoming segment of a road and a driving distance of a vehicle, and a speed measuring instrument may provide a current speed of the vehicle. A slope sensor may provide information on whether the upcoming segments of a road have a gradient according to each segment and gradient data (e.g., about an angle, an incline, a slope and the like). An acceleration sensor and a drive torque may provide information necessary to calculate a weight of a vehicle.

That is, it is possible to disclose the operation of a mechanism in which the processor 115 calculates a target battery SOC value based on receiving, as inputs, information on two or more distinct segments of a first forwarding driving segment and a second upcoming segment. The information may include, for example, a gradient, a distance, and/or a speed limit of each of the upcoming segments, received from peripheral devices.

In 203, the expected battery SOC demand value may be determined for each segment based on the obtained upcoming segment information on each of the segments. The expected battery SOC demand value may be determined/calculated according to at least a first upcoming segment and a second upcoming segment or more segments that are discriminated based on information obtained through peripheral devices of the vehicle. For example an upcoming segment may be split into two or more upcoming segments based on the information obtained via the peripheral devices.

The expected battery SOC demand value may be an expected battery discharge output value if a first upcoming segment of a road and a second upcoming segment of a road are uphill (e.g., ascending road). In this case, the expected battery discharge output value may be obtained by subtracting an expected fuel cell power generation output value from an expected gradient driving output value (e.g., expected driving output when the vehicle is being driven on the first and/or second upcoming segments of the road). For example, the fact that the first upcoming segment of a road and the second upcoming segment of a road are uphill may be confirmed from the upcoming segment information obtained from the processor 115 and/or ccNc.

If the first upcoming segment of a road and the second upcoming segment of a road are downhill (descending road), the expected battery output value may be an expected battery charge output value. Herein, the expected battery charge output value may be an expected gradient driving output value during regenerative braking. The fact that the first upcoming segment of a road and the second upcoming segment of a road are downhill may also be confirmed from the upcoming segment information obtained from the processor 115 and/or ccNc.

In 205, the target battery SOC value in the current driving segment may be determined/calculated according to whether a shift of gradient occurs in the two or more upcoming segments. The target battery SOC value determination 205 may be performed in detail as shown in FIG. 2B.

Referring to FIG. 2B, 205 may include determining an expected battery charge/discharge energy demand(s) based on the expected battery charge/discharge output value(s) (2051), determining an expected battery SOC demand value(s) based on the expected battery charge/discharge energy demand(s) (2053), determining whether the expected battery SOC demand value has a same sign in successive upcoming segments (2055), comparing absolute values between an expected battery SOC demand value of a first upcoming segment and an expected battery SOC demand value of a second upcoming segment (2057), and determining a sign of the expected battery SOC demand value of the second upcoming segment and determining the target battery SOC value in the current driving segment according to the expected SOC demand value(s) and the determined sign (2059).

According to FIG. 2B, in 2051, the expected battery charge/discharge energy demand may be determined/calculated based on the expected battery charge/discharge output value(s). The expected battery charge/discharge energy demand may be determined by multiplying the expected battery charge/discharge output value(s) and an expected future driving time of the vehicle (e.g., for each upcoming segment, multiplying a corresponding expected battery charge/discharge output value by an expected future driving time of the vehicle on the upcoming segment).

For example, the expected battery output value may be obtained by a VCU based on a vehicle dynamics equation. The vehicle dynamics equation may be Equation 1, for example:

$$\begin{matrix}{F}_{t rction} = ( {F}_{drag} + {F}_{roll} + {F}_{grade} ) \\ = 0.5 ⋆ ρ ⋆ {C}_{d} ⋆ A ⋆ {V}^{2} + mg ⋆ ( {C}_{r} cos θ + sin θ )\end{matrix} \qquad [ Equation 1 ]$$

Here, F_{traction} is a traction force, F_{drag} is air drag, Fᵣₒₗₗ is rolling resistance, and F_{grade} is gradability. m is a vehicle weight, g is the acceleration of gravity, ρ is air density, C_{d} is an air resistance coefficient, A is a front area, and Cᵣ is a rolling resistance coefficient.

In 2053, the determining of the expected battery SOC demand value(s) (e.g., corresponding to each of the upcoming segments) based on the expected battery charge/discharge energy demand(s) (e.g., corresponding to each of the upcoming segments) may include dividing the expected battery charge/discharge energy demand(s) for two or more upcoming segments by an expected future driving time of the vehicle. Herein, the expected future driving time of the vehicle may be a value obtained by dividing a current segment distance by a vehicle speed. The expected SOC demand value may be determined for each segment of the two or more upcoming segments (e.g., using upcoming segment information corresponding to each of the two or more segments and by the methods disclosed herein, such as 201-203 in FIG. 2A and 2051-2053 in FIG. 2B).

In 2055, it may be determined whether the expected battery SOC demand value has a same sign in the successive first and second upcoming segments. For example, a determination may be made as to whether the first upcoming segment and the second upcoming segment are segments with continuous gradients (e.g., in a same direction, both uphill or both downhill) or have a shift of gradients (e.g., in different directions, one uphill and the other downhill, etc.) by determining whether expected battery SOC demand values for successive of the upcoming segments at 2053 have a same sign or different signs.

If the expected battery SOC demand values of the first upcoming segment and the second upcoming segment have a same value, it may be determined that the segments have continuous gradients, and the target battery SOC value in the current driving segment may be calculated and determined accordingly by determining whether the segments are successive uphill segments or successive downhill segments.

In 2057, the comparing of the absolute values between the expected battery SOC demand value of the first upcoming segment and the expected battery SOC demand value of the second upcoming segment may be performed when the expected battery SOC demand values of the first upcoming segment and the second upcoming segment do not have a same sign (e.g., have opposite signs at 2055). Herein, a shift of front gradients occurs based on it being determined that the expected battery SOC demand value of the first upcoming segment and the expected battery SOC demand value of the second upcoming segment have opposite signs.

In this case, the shift of front gradients may be divided into a driving distance of the first upcoming segment and a driving distance of the second upcoming segment, and thus the target battery SOC value in the current driving segment may be calculated. That is, whether a driving distance is long or short may be determined by comparing the absolute values between the expected battery SOC demand value of the first upcoming segment and the expected battery SOC demand value of the second upcoming segment.

In 2059, the determining of the sign of the expected battery SOC demand value of the second upcoming segment and the determining of the target battery SOC value in the current driving segment according to the determination result may be performed when the expected battery SOC demand value of the first upcoming segment has a greater absolute value than the expected battery SOC demand value of the second upcoming segment at 2057.

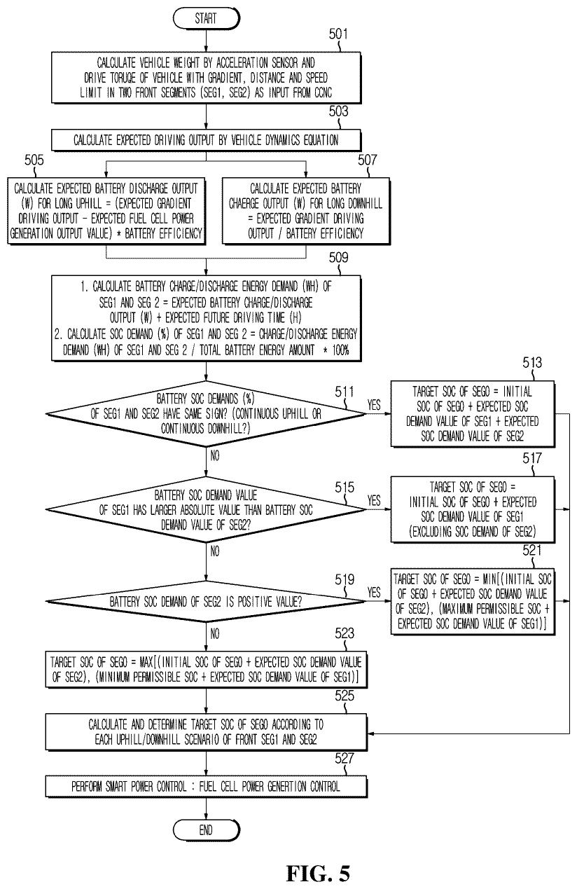

In this case, if the second upcoming segment has a longer driving distance than the first upcoming segment, whether the second upcoming segment is uphill or downhill may be determined according to whether the expected battery SOC demand value of the second upcoming segment is a positive value. Depending on whether the second upcoming segment is uphill or downhill, the target battery SOC value may be determined. The method for determining a target battery SOC value, which has been described with steps of FIG. 2B, will be described in detail in FIG. 5.

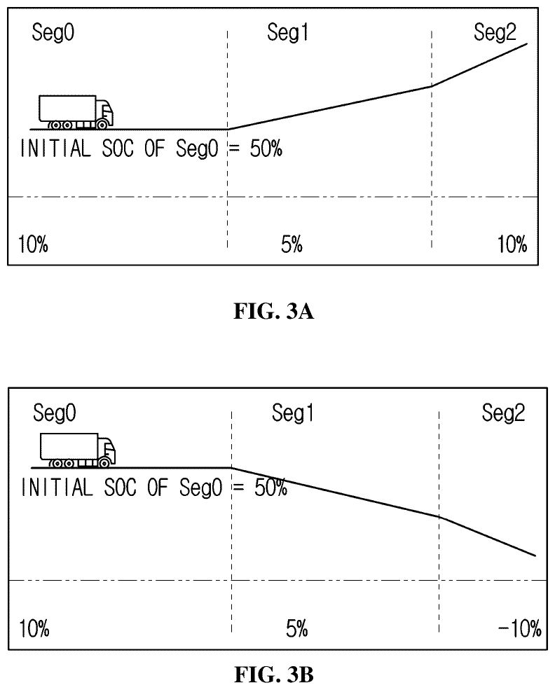

FIG. 3A and FIG. 3B are graphs showing estimation results of changes in a target battery SOC value for each upcoming segment of a road according to a continuous front gradient, when the results are obtained from a device for determining a target battery SOC value in a vehicle according to another example of the present disclosure.

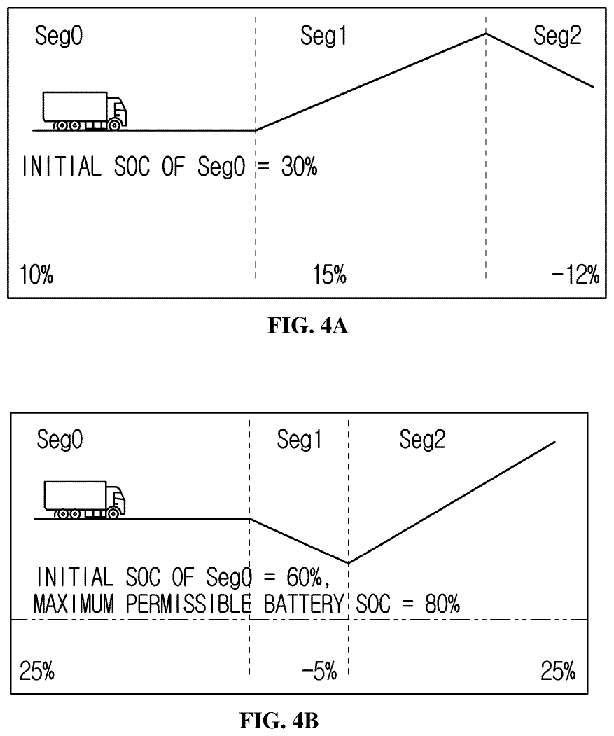

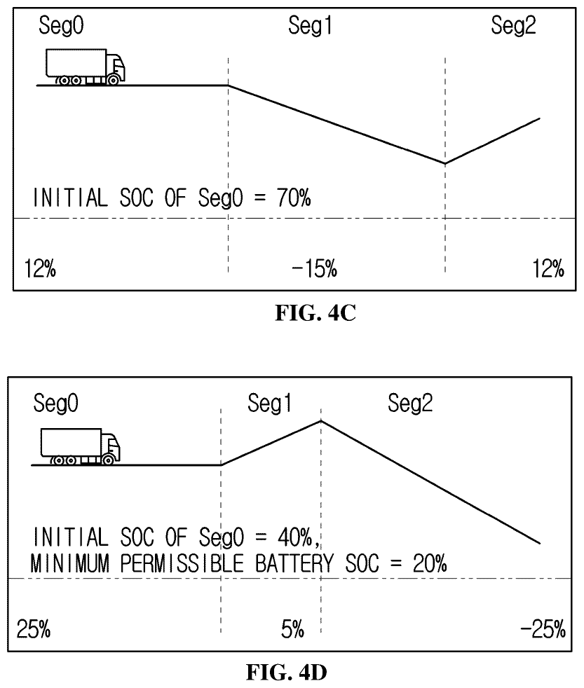

Referring to FIG. 4A and FIG. 4B, a method for determining a target battery SOC in a current driving segment according to the present disclosure may calculate a target battery SOC value according to an uphill/downhill change in a first upcoming segment and a second upcoming segment. In FIG. 3A and FIG. 3B, both the first upcoming segment and the second upcoming segment are uphill or downhill. That is, a process of controlling fuel cell power generation is described for when it is determined that expected battery SOC demand values of the first upcoming segment and the expected battery SOC demand value of the second upcoming segment have a same sign. A process of controlling fuel cell power generation when a shift of gradient occurs in the first upcoming segment and the second upcoming segment will be described in detail in FIG. 4A to FIG. 4D.

FIG. 3A is a process of determining a target battery SOC if the first upcoming segment and the second upcoming segment are uphill and a battery SOC value is expected to be discharged. FIG. 3B is a process of determining a target battery SOC if the first upcoming segment and the second upcoming segment are downhill and a battery SOC value is expected to be charged. In case front gradients are continuous, since expected battery SOC demand values of the first upcoming segment and the second upcoming segment have a same sign, a vehicle needs to secure the expected battery SOC demand values before reaching the first upcoming segment so that the vehicle can finish driving on the second upcoming segment without undergoing a lack of battery SOC value. Accordingly, a target battery SOC value in a current driving segment may be determined as a value obtained by summing up an initial battery SOC value of the current driving segment, an expected battery SOC demand value of the first upcoming segment, and an expected battery SOC demand value of the second upcoming segment.

The initial battery SOC value of the current driving segment is a battery SOC value calculated by a process according to the present disclosure based on the vehicle is driving on a previous driving segment. The “initial battery SOC” may be a battery SOC value at entry into the current driving segment. The initial battery SOC value of the current driving segment may be a value that is assumed according to a situation.

For example, in FIG. 3A, a target battery SOC value in a current driving segment may be determined as 65% that is obtained by summing up 50% for an initial battery SOC value of the current driving segment, 5% for an expected battery SOC demand value of the first upcoming segment, and 10% for an expected battery SOC demand value of the second upcoming segment. In FIG. 3B, a target battery SOC value in a current driving segment may be determined as 35% that is obtained by summing up 50% for an initial battery SOC value of the current driving segment, −5% for an expected battery SOC demand value of the first upcoming segment, and −10% for an expected battery SOC demand value of the second upcoming segment.

FIGS. 4A, 4B, 4C and 4D are graphs showing estimation results of changes in a target battery SOC value for each upcoming segment of a road according to a shift of front gradient, when the results are obtained from a device for determining a target battery SOC value in a vehicle. FIGS. 4A, 4B, 4C and 4D will be referenced to describe a process of determining a target battery SOC value required for smart power control in various scenarios of gradient shift through a device for determining a target battery SOC value of a vehicle according to the present disclosure.

For convenience of description, scenarios represent various cases according to a type of gradient shift and a driving distance in a first upcoming segment and a second upcoming segment. Seg 0 may mean a current driving segment in every scenario, Seg 1 may mean a first upcoming segment in every scenario, and Seg 2 may mean a second upcoming segment in every scenario.

Among various gradient shift scenarios, FIG. 4A and FIG. 4B correspond to a case in which an expected battery SOC demand value of the first upcoming segment has a greater absolute value than an expected battery SOC demand value of the second upcoming segment. That is, in this case, the first upcoming segment is uphill or downhill, and its driving distance is longer than that of the second upcoming segment. Herein, a target battery SOC value in a current driving segment may be determined by adding an initial battery SOC value of the current driving segment and the expected battery SOC demand value of the first upcoming segment. The expected battery SOC demand value of the second upcoming segment is expected.

In this case, if a shift of gradient occurs in the first upcoming segment and the second upcoming segment and the expected battery SOC demand value of the first upcoming segment and the expected battery SOC demand value of the second upcoming segment have opposite signs, adding the expected battery SOC demand values makes the values offset against each other, which results in a smaller total expected battery SOC demand value, and thus an expected battery SOC demand value necessary for driving on the first upcoming segment may not be secured. Accordingly, in case the expected battery SOC demand value of the first upcoming segment has a greater absolute value than the expected battery SOC demand value of the second upcoming segment, only the expected battery SOC demand value of the first upcoming segment may be reflected in a target battery SOC value.

For example, in FIG. 4A, a shift of gradient from an uphill to a downhill occurs in a first upcoming segment and a second upcoming segment, and a driving distance of the first upcoming segment is longer than a driving distance of the second upcoming segment. Accordingly, a target battery SOC value in a current driving segment may be determined as 45% that is obtained by adding 30% for an initial battery SOC value of the current driving segment and 15% for an expected battery SOC demand value of the first upcoming segment (e.g., the target battery SOC value omits the expected battery SOC demand value of the second upcoming segment based on the first upcoming segment being longer than the second upcoming segment and the switch from uphill to downhill).

For example, in FIG. 4C, a shift of gradient from a downhill to an uphill occurs in a first upcoming segment and a second upcoming segment, and a driving distance of the first upcoming segment is longer than a driving distance of the second upcoming segment. Accordingly, a target battery SOC value in a current driving segment may be determined as 55% that is obtained by adding 70% for an initial battery SOC value of the current driving segment and −15% for an expected battery SOC demand value of the first upcoming segment (e.g., the target battery SOC value omits the expected battery SOC demand value of the second upcoming segment based on the first upcoming segment being longer than the second upcoming segment and the switch from uphill to downhill).

Among various gradient shift scenarios, FIG. 4B and FIG. 4D correspond to a case in which an expected battery SOC demand value of a second upcoming segment has a greater absolute value than an expected battery SOC demand value of a first upcoming segment. That is, in this case, the second upcoming segment is uphill or downhill, and its driving distance is longer than that of the first upcoming segment. Herein, in order to calculate a target battery SOC value in a current driving segment, it may be determined whether the expected battery SOC demand value of the second upcoming segment has a positive sign.

If the expected battery SOC demand value of the second upcoming segment has a positive sign, the second upcoming segment may be determined as uphill. In this case, the target battery SOC value in the current driving segment may be determined as a smaller value between a value obtained by adding an initial battery SOC value of the current driving segment and the expected battery SOC demand value of the second upcoming segment and a value obtained by adding a maximum permissible battery SOC value and the expected battery SOC demand value of the first upcoming segment.

If the expected battery SOC demand value of the second upcoming segment has a negative sign, the second upcoming segment may be determined as downhill. In this case, the target battery SOC value in the current driving segment may be determined as a larger value between a value obtained by adding an initial battery SOC value of the current driving segment and the expected battery SOC demand value of the second upcoming segment and a value obtained by adding a minimum permissible battery SOC value and the expected battery SOC demand value of the first upcoming segment.

In this case, if a shift of gradient occurs in the first upcoming segment and the second upcoming segment (e.g., from uphill to downhill or downhill to uphill), the expected battery SOC demand value of the first upcoming segment and the expected battery SOC demand value of the second upcoming segment have opposite signs, and the expected battery SOC demand value of the second upcoming segment is greater than the expected battery SOC demand value of the first upcoming segment. In this case, if only the expected battery SOC demand value of the first upcoming segment is secured, an expected battery SOC demand value for driving on the second upcoming segment may be lacking/insufficient. Accordingly, in case the expected battery SOC demand value of the second upcoming segment has a greater absolute value than the expected battery SOC demand value of the first upcoming segment, the expected battery SOC demand value for driving on the second upcoming segment may be secured. Herein, a minimum expected battery SOC demand value for driving on the first upcoming segment may be calculated to be secured.

For example, in FIG. 4B, a shift of gradient from an uphill to a downhill occurs in a first upcoming segment and a second upcoming segment, and a driving distance of the second upcoming segment is longer than a driving distance of the first upcoming segment. As the second upcoming segment is uphill, an expected battery SOC demand value of the second upcoming segment is a positive value. Accordingly, the target battery SOC value in the current driving segment may be determined as 75%: the smaller value between 85% obtained by adding 60% for the initial battery SOC value of the current driving segment and 25% for the expected battery SOC demand value of the second upcoming segment and 75% obtained by adding 80% for the maximum permissible battery SOC value and −5% for the expected battery SOC demand value of the first upcoming segment.

In FIG. 4D, a shift of gradient from a downhill to an uphill occurs in a first upcoming segment and a second upcoming segment, and a driving distance of the second upcoming segment is longer than a driving distance of the first upcoming segment. As the second upcoming segment is downhill, an expected battery SOC demand value of the second upcoming segment is a negative value. Accordingly, the target battery SOC value in the current driving segment may be determined as 25%: the larger value between 20% obtained by adding 40% for an initial battery SOC demand value of the current driving segment and −25% for the expected battery SOC demand value of the second upcoming segment and 25% obtained by adding 20% for the minimum permissible battery SOC value and 5% for the expected battery SOC demand value of the first upcoming segment.

FIG. 5 is a flowchart of an operating mechanism of a device for determining a target battery SOC value according to another example of the present disclosure. Referring to FIG. 5, a detailed method for determining a target battery SOC value according to the present disclosure may determine whether a shift of gradient occurs in an upcoming segment of a road of a vehicle and calculate and determine a target battery SOC value in a current driving segment according to various gradient shift situations.

For convenience, FIG. 5 is described by way of an example in which the steps are performed by a processor circuit. One, some, or all steps of the example method of FIG. 5, or portions thereof, may be performed by one or more other circuits. One or some, steps of the example method of FIG. 5 may be omitted, performed in other orders, and/or otherwise modified, and/or one or more additional steps may be added.

A process of operating a device for determining a target battery SOC value may be described with reference to FIG. 5 as follows. First, the battery SOC correction device may be initiated by receiving, as inputs, information on whether two or more distinguished upcoming segments to be covered in the future have a gradient, a driving distance of each segment and a speed limit of a vehicle may be received from a peripheral device of the vehicle and receiving a weight of the vehicle from a vehicle acceleration sensor and a drive torque (501).

Based on the vehicle dynamics equation mentioned in Equation 1, an expected gradient driving output value of the two or more upcoming segments may be calculated (503). Herein, the expected gradient driving output value may be an expected required battery output value.

In case an upcoming segment is uphill, the expected required battery output value may be an expected battery discharge output value, which may be calculated by multiplying battery efficiency and a value obtained by subtracting an expected fuel cell power generation output value from the expected gradient driving output value (505). In case the upcoming segment is downhill, the expected required battery output value may be an expected battery charge output value, which may be calculated by dividing the expected gradient driving output value by battery efficiency (507).

Next, total expected battery charge/discharge SOC demand values in a first upcoming segment Seg 1 and in a second upcoming segment Seg 2 may be calculated based on the expected battery charge/discharge output values obtained at steps S507 and S507 and then be converted into battery SOC demand values (509).

It may be determined whether the converted battery SOC demand values for the two or more upcoming segments have a same sign (511). Depending on whether they have a same sign, it may be determined whether the upcoming segments are continuous uphill or continuous downhill (e.g., both uphill or both downhill) and/or whether a shift of gradient occurs (e.g., if there is a change from uphill to downhill and/or downhill to uphill). If the converted battery SOC demand values have the same sign, the first upcoming segment and the second upcoming segment may be determined as continuous gradients (e.g., continuously uphill or continuously downhill, not necessarily a same gradient). In a case of continuous gradients herein, a target battery SOC value in a current driving segment may be determined by summing up an initial battery SOC value of the current driving segment, an expected battery SOC demand value of the first upcoming segment, and an expected battery SOC demand value of the second upcoming segment (513).

If the expected battery SOC demand values of the first upcoming segment and the second upcoming segment do not have a same sign, it may be determined that a shift of gradient occurs. Herein, the expected battery SOC demand value of the first upcoming segment and the expected battery SOC demand value of the second upcoming segment may further be compared with respect absolute values (515). Herein, if the expected battery SOC demand value of the first upcoming segment has a larger absolute value, it may be determined that the first upcoming segment has a longer driving distance than the second upcoming segment, and the first upcoming segment may be expected to be uphill or downhill. In this case, a target battery SOC value in a current driving segment may be determined by adding an initial battery SOC value of the current driving segment and the expected battery SOC demand value of the first upcoming segment (517).

If the expected battery SOC demand value of the second upcoming segment has a greater absolute value than the expected battery SOC demand value of the first upcoming segment, it may be determined that the second upcoming segment has a longer driving distance. In this case, it may be further determined whether the expected battery SOC demand value of the second upcoming segment is a positive value (519).

If the expected battery SOC demand value of the second upcoming segment is a positive value, the target battery SOC value in the current driving segment may be determined as a smaller value between a value obtained by adding an initial battery SOC value of the current driving segment and the expected battery SOC demand value of the second upcoming segment and a value obtained by adding a maximum permissible battery SOC value and the expected battery SOC demand value of the first upcoming segment (521).

If the expected battery SOC demand value of the second upcoming segment is a negative value, the target battery SOC value in the current driving segment may be determined as a larger value between a value obtained by adding an initial battery SOC value of the current driving segment and the expected battery SOC demand value of the second upcoming segment and a value obtained by adding a minimum permissible battery SOC value and the expected battery SOC demand value of the first upcoming segment (523).

Any one of the target battery SOC values determined at steps S513, S517, S521 and S523 may be calculated and determined as a target battery SOC value in a current driving segment according to uphill/downhill scenarios in a first upcoming segment and a second upcoming segment (525).

For the determined target battery SOC value of the current driving segment at S525, it is possible to perform smart power control to secure an expected battery SOC value necessary for the upcoming segment and the second upcoming segment in advance (527).

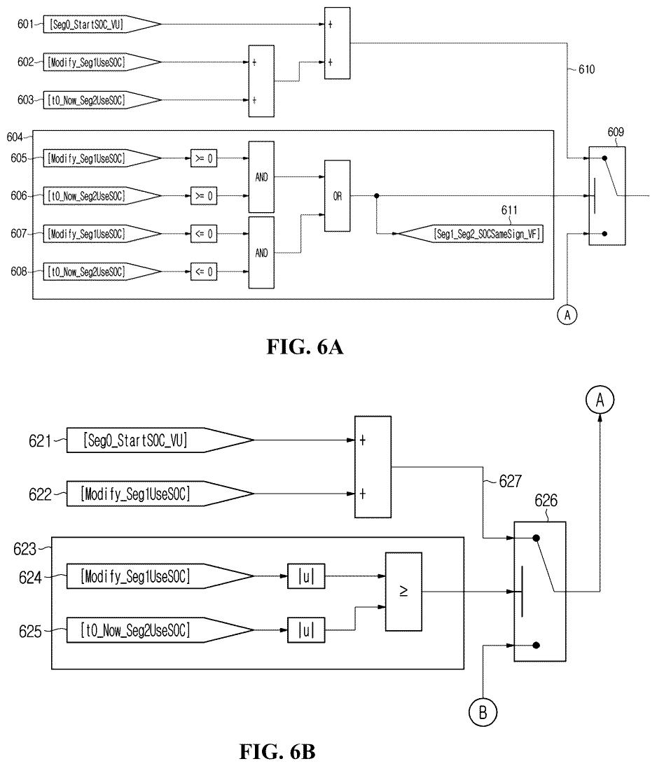

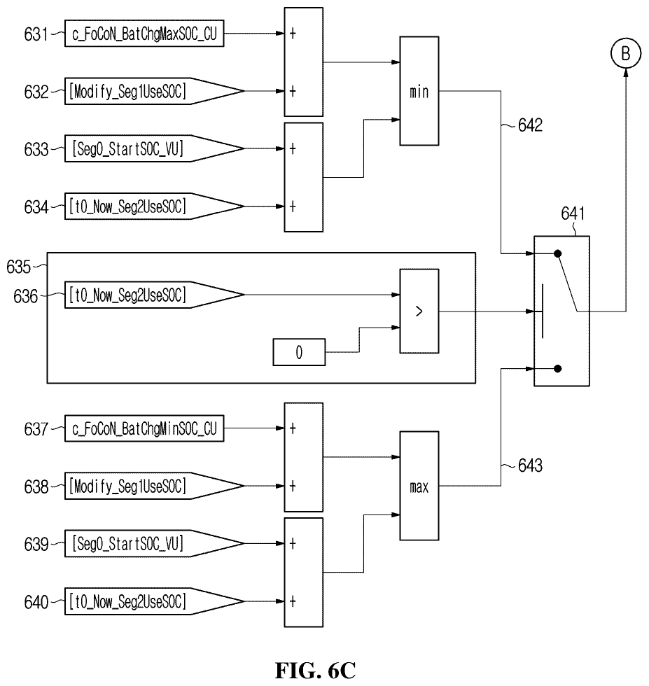

FIGS. 6A, 6B and 6C are views showing internal circuit structures of a process of implementing an operating mechanism for a device for determining a target battery SOC value according to another example of the present disclosure.

Referring to FIGS. 6A, 6B and 6C, a specific target battery SOC value according to various gradient shift situations of an upcoming segment of a road of a vehicle according to the present disclosure may be calculated by comparing respective battery SOC demand values of a first upcoming segment and a second upcoming segment. Hereinafter will be described a process of obtaining a target battery SOC value required for smart power control in various scenarios of continuous gradients and gradient shifts through a device for determining a target battery SOC of a vehicle according to the present disclosure.

FIG. 6A expresses a circuit for determining a target battery SOC value to be charged/discharged in a current driving segment when at least two or more upcoming segments have continuous gradients. First, in order to obtain the target battery SOC value in the current driving segment, an initial battery SOC value of the current driving segment (601), an expected battery SOC demand value of the first upcoming segment (602), and an expected battery SOC demand value of the second upcoming segment (603) may be input.

Depending on whether the expected battery SOC demand value of the first upcoming segment and the expected battery SOC demand value of the second upcoming segment have an identical sign, a coupling direction of a switch may be determined, and the circuit part expressed by 604 may correspond to a determination circuit representing a condition for determining the coupling direction of the switch (604). The switch may correspond to a device capable of selecting a method for determining a target battery SOC value of a current driving segment according to a circuit condition and whether it is applicable (609).

The determination circuit corresponding to the condition for determining the coupling direction of the switch will be described in detail below. When the expected battery SOC demand value of the first upcoming segment and the expected battery SOC demand value of the second upcoming segment have an identical sign, the expected battery SOC demand value of the first upcoming segment may be a positive value (605) and the expected battery SOC demand value of the second upcoming segment may also be a positive value (606), or the expected battery SOC demand value of the first upcoming segment may be a negative value (607) and the expected battery SOC demand value of the second upcoming segment may also be a negative value (608). If a condition for the above identical signs is satisfied, the switch may be coupled in the upward direction (610). Herein, a target battery SOC value in a current driving segment may be determined as a value obtained by summing up the input values, that is, the initial battery SOC value of the current driving segment, the expected battery SOC demand value of the first upcoming segment, and the expected battery SOC demand value of the second upcoming segment. Herein, expected battery SOC demand values of at least two or more upcoming segments may be values that are corrected through a battery SOC correction device according to whether the upcoming segments have continuous gradients.

If the expected battery SOC demand value of the first upcoming segment and the expected battery SOC demand value of the second upcoming segment do not have an identical sign, the switch of the circuit may be coupled in the downward direction and proceed to the circuit of FIG. 6B. In addition, if the expected battery SOC demand value of the first upcoming segment and the expected battery SOC demand value of the second upcoming segment are identical to each other (611), the voltage of a fuel cell may be measured through voltage feedback (VF) in a FCEV and be forwarded to the processor 115 so that a target battery SOC value in the current driving segment may be calculated.

FIG. 6B expresses a circuit for determining a target battery SOC value to be charged/discharged in a current driving segment when a gradient shift occurs in at least two or more upcoming segments and a first upcoming segment is uphill or downhill with a longer driving distance than a second upcoming segment.

The process may proceed to the circuit of FIG. 6B when the expected battery SOC demand value of the first upcoming segment and the expected battery SOC demand value of the second upcoming segment do not have an identical sign, and the circuit may receive, as an input, only an initial battery SOC value of the current driving segment 621 and the expected battery SOC demand value of the first upcoming segment. That is, the expected battery SOC demand value of the first upcoming segment (624) and the expected battery SOC demand value of the second upcoming segment (625) are compared (e.g., the absolute values of each are compared), if the expected battery SOC demand value of the first upcoming segment has a larger absolute value (623), the switch (626) may be coupled in the upward direction so that the target battery SOC value in the current driving segment may be determined by adding the initial battery SOC value of the current driving segment and the expected battery SOC demand value of the first upcoming segment (627). If the expected battery SOC demand value of the second upcoming segment has a larger absolute value, the switch may be coupled in the downward direction and proceed to the circuit of FIG. 6C.

FIG. 6C is a case in which a gradient shift occurs in at least two or more upcoming segments and a second upcoming segment is uphill or downhill with a longer driving distance than a first upcoming segment. This case expresses a circuit for determining a target battery SOC value to be charged/discharged in a current driving segment by considering whether the second upcoming segment is uphill or downhill.

The circuit of FIG. 6C is a case in which an expected battery SOC demand value of the first upcoming segment and an expected battery SOC demand value of the second upcoming segment do not have an identical sign and the expected battery SOC demand value of the second upcoming segment is larger than the expected battery SOC demand value of the first upcoming segment, and the switch (641) of the circuit may be coupled differently according to whether the expected battery SOC demand value of the second upcoming segment is a positive value (635).

First, when the expected battery SOC demand value of the second upcoming segment (636) is a positive value, a value obtained by adding an initial battery SOC value of a current driving segment (633) and the expected battery SOC demand value of the second upcoming segment (634) is compared with a value obtained by adding a maximum permissible battery SOC value (631) and the expected battery SOC demand value of the first upcoming segment (632), and then a smaller of the two values may be determined as a target battery SOC value of the current driving segment (642).

If the expected battery SOC demand value of the second upcoming segment is a negative value (643), a value obtained by adding an initial battery SOC value of a current driving segment (639) and the expected battery SOC demand value of the second upcoming segment (640) is compared with a value obtained by adding a minimum permissible battery SOC value (637) and the expected battery SOC demand value of the first upcoming segment (638), and then a larger of the two values may be determined as a target battery SOC value of the current driving segment.

That is, according to the present disclosure, based on upcoming segment information obtained for each segment of two or more upcoming segments of a road, an expected battery SOC change may be calculated according to whether a first upcoming segment of a road and a second upcoming segment of a road have continuous gradients or a gradient shift, and the expected battery SOC change may be converted into a target battery SOC value in a current driving segment. Thus, a fuel cell power generation output may be controlled, and a target battery SOC value may be secured sufficiently to be used in two or more upcoming segments. In addition, even when a gradient shift occurs in two or more upcoming segments, a target battery SOC value may be controlled not to be subtracted so that a necessary battery value may be secured for the upcoming segments.

The present disclosure is technically directed to providing a method and device for determining a target battery SOC of a vehicle according to various uphill/downhill changes in each driving segment based on information on an upcoming segment of a road obtained from a peripheral device of the device.

In addition, to solve technical problems of the present disclosure, the present disclosure is directed to providing a method and device for determining an expected battery SOC demand value by dividing a driving road of a vehicle into further segments and according whether the front segments have continuous gradients or a shift of gradients.

The technical problems solved by the present disclosure are not limited to the above technical problems and other technical problems which are not described herein will be clearly understood by a person having ordinary skill in the technical field, to which the present disclosure belongs, from the following description.

According to the present disclosure, a method is provided for determining a target battery SOC of vehicle. The method may comprise: obtaining upcoming segment information for each of at least two or more upcoming segments of an upcoming segment of a road, determining an expected battery SOC demand value of each segment based on the obtained upcoming segment information, determining and determining a target battery SOC demand value in a current driving segment according to whether the at least two or more upcoming segments shift gradients.

According to an example of the method of the present disclosure, wherein in order to calculate the expected battery SOC demand value of each segment based on the obtained upcoming segment information, the upcoming segment information is transmitted to segments that are distinguished at least into the current driving segment, a first upcoming segment, and a second upcoming segment.

According to an example of the method of the present disclosure, wherein the expected battery SOC demand value means an expected battery charge/discharge SOC demand value, wherein an expected battery charge/discharge energy demand is determined by multiplying an expected battery charge/discharge output value and an expected future driving time, and wherein the expected battery SOC demand value is determined by dividing the expected battery charge/discharge energy demand by a total battery energy value.

According to an example of the method of the present disclosure, further comprising determining whether the first upcoming segment and the second upcoming segment shift gradients, according to the expected battery SOC demand value has an identical sign.

According to an example of the method of the present disclosure, further comprising, based on a gradient shift occurring in the first upcoming segment and the second upcoming segment, comparing a driving distance of the first upcoming segment and a driving distance of the second upcoming segment by comparing an absolute value of a required battery SOC demand of the first upcoming segment and an absolute value of a required battery SOC demand of the second upcoming segment.

According to an example of the method of the present disclosure, further comprising, based on the driving distance of the second upcoming segment being longer, determining whether the second upcoming segment is uphill or downhill, according to whether the battery SOC demand value of the second upcoming segment is a positive value.

According to an example of the method of the present disclosure, wherein, based on no gradient shift occurring in the first upcoming segment and the second upcoming segment, a target battery SOC value in the current driving segment is determined by adding an expected battery SOC demand value of the first upcoming segment and an expected battery SOC demand value of the second upcoming segment to an initial SOC value of the current driving segment.

According to an example of the method of the present disclosure, wherein, based on the gradient shift occurring in the first upcoming segment and the second upcoming segment and the driving distance of the first upcoming segment being longer, the target battery SOC value in the current driving segment is determined by adding the expected battery SOC demand value of the first upcoming segment to the initial SOC value of the current driving segment.

According to an example of the method of the present disclosure, wherein, when the second upcoming segment is determined as uphill based on the gradient shift occurring in the first upcoming segment and the second upcoming segment, the driving distance of the second upcoming segment being longer, and the battery SOC demand value of the second upcoming segment being a positive value, the target battery SOC value in the current driving segment is determined by adding the expected battery SOC demand value of the second upcoming segment to the initial SOC value of the current driving segment, and a battery SOC demand value to be charged in the first upcoming segment, which is a short downhill, is secured by the determining.

According to an example of the method of the present disclosure, wherein, when the second upcoming segment is determined as downhill based on the gradient shift occurring in the first upcoming segment and the second upcoming segment, the driving distance of the second upcoming segment being longer, and the battery SOC demand value of the second upcoming segment being a negative value, the target battery SOC value in the current driving segment is determined by adding the expected battery SOC demand value of the second upcoming segment to the initial SOC value of the current driving segment, and a battery SOC demand value to be discharged in the first upcoming segment, which is a short uphill, is secured by the determining.

According to another example of the present disclosure, a device is provided for determining a target battery SOC of a vehicle in a fuel cell power generation control device of the vehicle for controlling a battery SOC demand value by using upcoming segment information. The device may comprising: a peripheral device configured to obtain at least one or more of a driving distance of each segment of an upcoming segment of a road, a speed limit of a vehicle, and whether there is a gradient as upcoming segment information, a memory configured to store at least one instruction: and a processor configured to execute the at least one instruction stored in the memory, wherein the processor is further configured to: calculate an expected battery SOC demand value based on the upcoming segment information that is input from the peripheral device, and calculate and determine a target battery SOC demand value in a current driving segment according to whether a gradient shift occurs in at least two or more upcoming segments.

According to an example of the device of the present disclosure, wherein, in order to calculate the expected battery SOC demand value of each segment based on the obtained upcoming segment information, the upcoming segment information is transmitted to segments that are distinguished at least into the current driving segment, a first upcoming segment, and a second upcoming segment.

According to an example of the device of the present disclosure, wherein the expected battery SOC demand value means an expected battery charge/discharge SOC demand value, wherein an expected battery charge/discharge energy demand is determined by multiplying an expected battery charge/discharge output value and an expected future driving time, and wherein the expected battery SOC demand value is determined by dividing the expected battery charge/discharge energy demand by a total battery energy value.

According to an example of the device of the present disclosure, wherein the processor is further configured to determine whether the first upcoming segment and the second upcoming segment shift gradients, according to the expected battery SOC demand value has an identical sign.

According to an example of the device of the present disclosure, wherein, based on a gradient shift occurring in the first upcoming segment and the second upcoming segment, the processor is further configured to compare a driving distance of the first upcoming segment and a driving distance of the second upcoming segment by comparing an absolute value of a required battery SOC demand of the first upcoming segment and an absolute value of a required battery SOC demand of the second upcoming segment.

According to an example of the device of the present disclosure, wherein, based on the driving distance of the second upcoming segment being longer, the processor is further configured to determine whether the second upcoming segment is uphill or downhill, according to whether the battery SOC demand value of the second upcoming segment is a positive value.

According to an example of the device of the present disclosure, wherein, based on no gradient shift occurring in the first upcoming segment and the second upcoming segment, the processor is further configured to determine a target battery SOC value in the current driving segment by adding an expected battery SOC demand value of the first upcoming segment and an expected battery SOC demand value of the second upcoming segment to an initial SOC value of the current driving segment.

According to an example of the device of the present disclosure, wherein, based on the gradient shift occurring in the first upcoming segment and the second upcoming segment and the driving distance of the first upcoming segment being longer, the processor is further configured to determine the target battery SOC value in the current driving segment by adding the expected battery SOC demand value of the first upcoming segment to the initial SOC value of the current driving segment.

According to an example of the device of the present disclosure, wherein, when the second upcoming segment is determined as uphill based on the gradient shift occurring in the first upcoming segment and the second upcoming segment, the driving distance of the second upcoming segment being longer, and the battery SOC demand value of the second upcoming segment being a positive value, the processor is further configured to determine the target battery SOC value in the current driving segment by adding the expected battery SOC demand value of the second upcoming segment to the initial SOC value of the current driving segment and thus to secure a battery SOC demand value to be charged in the first upcoming segment, which is a short downhill, by the determining.

According to an example of the device of the present disclosure, wherein, when the second upcoming segment is determined as downhill based on the gradient shift occurring in the first upcoming segment and the second upcoming segment, the driving distance of the second upcoming segment being longer, and the battery SOC demand value of the second upcoming segment being a negative value, the processor is further configured to determine the target battery SOC value in the current driving segment by adding the expected battery SOC demand value of the second upcoming segment to the initial SOC value of the current driving segment and thus secure a battery SOC demand value to be discharged in the first upcoming segment, which is a short uphill, by the determining.

According to the present disclosure, it is possible to provide a method and device for determining a battery SOC of a vehicle by predicting a necessary battery SOC for an upcoming segment of a segment through upcoming segment information obtained from a peripheral device of the vehicle and further by dividing the forwarding driving segment at least into a first upcoming segment, a second upcoming segment and more and accurately predicting a battery SOC demand value necessary for each segment.

According to the present disclosure, it is possible to provide a method and device for determining a target battery SOC of a vehicle by dividing an upcoming segment of a segment at least into a first upcoming segment, a second upcoming segment and more, determining whether the segments have continuous gradients or a shift of gradients, and securing an optimal target battery SOC value for a current driving segment according to various situations.

According to the present disclosure, even for a large commercial FCEV with a very heavy weight, it is possible to sufficiently secure a target battery SOC value necessary for future driving by charging a battery beforehand or reducing a power generation amount before continuous uphill driving or continuous downhill driving.

According to the present disclosure, it is possible to secure a target battery SOC value necessary for future driving by applying control that does not reduce the target battery SOC value even after a large commercial FCEV with a very heavy weight has driven on a segment with a shift of gradient.

The effects obtainable from the present disclosure are not limited to the above-mentioned effects, and other effects not mentioned herein will be clearly understood by those skilled in the art through the following descriptions.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by a device of a vehicle and for controlling power generation based on a target battery state of charge (SOC) of a battery of the vehicle, the method comprising:
obtaining upcoming segment information for each of at least two upcoming segments of a road, wherein the at least two upcoming segments of the road are segments of the road to be driven on following a current segment of the road;
determining, based on the obtained upcoming segment information, expected battery SOC demand values for the at least two upcoming segments;
based on whether there is a change in direction of gradients of the at least two upcoming segments and based on the expected battery SOC demand values, determining a target battery SOC value for a current driving segment; and
controlling, based on the target battery SOC demand value, power generation by a fuel cell of the vehicle.

2. The method of claim 1, wherein the determining the expected battery SOC demand values comprises determining, based on the obtained upcoming segment information, a first expected battery SOC demand value of a first upcoming segment of the at least two upcoming segments and a second expected battery SOC demand value of a second upcoming segment of the at least two upcoming segments, wherein the second upcoming segment is to be driven on after the first upcoming segment.

3. The method of claim 1, wherein the determining the expected battery SOC demand values comprises:
for each upcoming segment of the at least two upcoming segments, determining an expected battery SOC demand value by:
determining an expected battery charge/discharge energy demand by multiplying an expected battery charge/discharge output value for the upcoming segment and an expected future driving time for the upcoming segment, and
dividing the expected battery charge/discharge energy demand by a total battery energy value.

4. The method of claim 2, further comprising determining, based on a sign of the first expected battery SOC demand value and a sign of the second expected battery SOC demand value, whether there is a change in direction between a first gradient of the first upcoming segment and a second gradient of the second upcoming segment.

5. The method of claim 4, further comprising, based on a change in direction between the first gradient and the second gradient, comparing an absolute value of the first expected battery SOC demand value and an absolute value of the second expected battery SOC demand value.

6. The method of claim 5, further comprising, based on the absolute value of the second expected battery SOC demand value being greater than the absolute value of the first expected battery SOC demand value, determining, based on a sign of the second expected SOC demand value, whether the second upcoming segment is uphill or downhill.

7. The method of claim 4, further comprising:
based on no change in direction between the first gradient and the second gradient, determining the target battery SOC value as a sum of the first expected battery SOC demand value, the second expected battery SOC demand value, and an initial SOC value of the current driving segment.

8. The method of claim 5, further comprising:
based on the absolute value of the first expected battery SOC demand value being greater than the absolute value of the second expected battery SOC demand value, determining the target battery SOC value as a sum of the first expected battery SOC demand value and an initial SOC value of the current driving segment.

9. The method of claim 6, further comprising:
based on the determining the second upcoming segment is uphill determining the target battery SOC value as a sum of the second expected battery SOC demand value of the second upcoming segment and an initial SOC value of the current driving segment, and a battery SOC demand value to be charged in the first upcoming segment, which is a short downhill, is secured by the determining.

10. The method of claim 6, further comprising:
based on the determining the second upcoming segment is downhill, determining the target battery SOC value as a sum of the second expected battery SOC demand value and an initial SOC value of the current driving segment, and a battery SOC demand value to be discharged in the first upcoming driving segment, which is a short uphill, is secured by the determining.

11. A device for determining a target battery state of charge (SOC) for fuel cell power generation control of a fuel cell of a vehicle, the device comprising:
a peripheral device configured to obtain upcoming segment information about at least two upcoming segments of a road comprising a current segment on which the vehicle is driving, wherein the upcoming segment information indicates gradients of the at least two upcoming segments and comprises at least one of:
a driving distance of each of the at least two upcoming segments, or
a speed limit of each of the at least two upcoming segments;
a memory storing at least one instruction; and
a processor configured to execute the at least one instruction stored in the memory,
wherein the at least one instruction, when executed by the processor, configures the processor to:
determine, based on the upcoming segment information from the peripheral device, expected battery SOC demand values for the at least two upcoming segments,
based on whether there is a change in direction of gradients of the at least two upcoming segments and based on the expected battery SOC demand values, a target battery SOC value for a current driving segment; and
control, based on the target battery SOC demand value, power generation by the fuel cell of the vehicle.

12. The device of claim 11, wherein the processor is configured to determine the expected battery SOC demand values by determining, based on the obtained upcoming segment information, a first expected battery SOC demand value of a first upcoming segment of the at least two upcoming segments and a second expected battery SOC demand value of a second upcoming segment of the at least two upcoming segments, wherein the second upcoming segment is to be driven on after the first upcoming segment.

13. The device of claim 11, wherein processor is configured to, for an upcoming segment of the at least two upcoming segments, determine an expected battery SOC demand value by:
determining an expected battery charge/discharge energy demand by multiplying an expected battery charge/discharge output value for the upcoming segment and an expected future driving time for the upcoming segment, and
dividing the expected battery charge/discharge energy demand by a total battery energy value.

14. The device of claim 12, wherein the processor is further configured to determine, based on a sign of the first expected battery SOC demand value and a sign of the expected battery SOC demand value, whether there is a change in direction between a first gradient of the first upcoming segment and a second gradient of the second upcoming segment.

15. The device of claim 14, wherein, based on a change in direction between the first gradient and the second gradient, the processor is further configured to compare an absolute value of the first expected battery SOC demand value and an absolute value of the second expected battery SOC demand value.

16. The device of claim 15, wherein, based on the absolute value of the second expected battery SOC demand value being greater than the absolute value of the first expected battery SOC demand value, the processor is further configured to determine, based on a sign of the second expected SOC demand value, whether the second upcoming segment is uphill or downhill.

17. The device of claim 14, wherein, based on no change in direction between the first gradient and the second gradient, the processor is further configured to determine the target battery SOC value as a sum of the first expected battery SOC demand value, the second expected battery SOC demand value and an initial SOC value of the current driving segment.

18. The device of claim 15, wherein the processor is further configured to, based on the absolute value of the first expected battery SOC demand value being greater than the absolute value of the second expected battery SOC demand value, determine the target battery SOC value as a sum of the first expected battery SOC demand value and an initial SOC value of the current driving segment.

19. The device of claim 16, wherein the processor is further configured to:
based on a determination that the second upcoming segment is uphill, determine the target battery SOC value as a first sum of the second expected battery SOC demand value of the second upcoming segment and an initial SOC value of the current driving segment when the first sum is less than a first threshold value; or
based on a determination that the second upcoming segment is downhill, determine the target battery SOC value as a second sum of the second expected battery SOC demand value and an initial SOC value of the current driving segment when the second sum is greater than a second threshold SOC value.

20. A fuel cell vehicle comprising:
one or more sensors configured to obtain gradient information about at least two upcoming segments of a road comprising a current segment on which the fuel cell vehicle is driving; and
a computing device comprising:
a processor; and
memory storing instructions that, when executed by the processor, configure the computing device to:
determine, based the gradient information indicating a change in direction of gradients of the at least two upcoming segments, one of a plurality of algorithms for determining a target battery SOC demand value for a current driving segment, wherein each of the plurality of algorithms is different from a first algorithm that uses a sum of expected battery SOC demand values for the at least two upcoming segments, and wherein the first algorithm is configured to be used when there is no change in direction of gradients of the at least two upcoming segments; and
control, based on the target battery SOC demand value, power generation by a fuel cell of the fuel cell vehicle.
